(19) United States
(12) Patent Application Publication
(10) Pub. No.: US 2026/0217214 A1
(43) Pub. Date: Jul. 30, 2026

(54) METHOD OF OPENING AN OPENING ELEMENT OF A VEHICLE

(71) Applicant: Valeo Comfort and Driving Assistance, Créteil (FR)

(72) Inventors: Georges Djokic, Créteil (FR); Kawtar Es-Saghir, Créteil (FR); Eloi Desbazeilles, Créteil (FR); Onur Oguz, Créteil (FR)

(73) Assignee: Valeo Comfort and Driving Assistance, Créteil (FR)

(21) Appl. No.: 19/146,099

(22) PCT Filed: Dec. 11, 2023
(86) PCT No.: PCT/EP2023/085078

§ 371 Date: Jul. 7, 2025

(30) Foreign Application Priority Data
Jan. 6, 2023 (FR) FR2300182

(51) Int. Cl. B60R 25/01; B60R 25/20; B60R 25/24; B60R 25/25; B60R 25/31

(52) U.S. Cl. CPC B60R 25/01; B60R 25/209; B60R 25/24; B60R 25/257; B60R 25/31; B60R 2325/101

(57) ABSTRACT

Described is a method of opening an opening element of a vehicle. The method includes authentication of an identifier by an electronic control unit of the vehicle and locating the identifier in a first proximity zone around the vehicle. When the identifier is located in the first proximity zone, the electronic control unit detects whether the identifier has remained static in the first proximity zone. When the identifier has remained static in the first proximity zone, the electronic control unit detects whether the identifier has entered a second proximity zone around the opening element. When the identifier enters the second proximity zone, a confirmation signal of intention to open the opening element is sent to the identifier. The electronic control unit detects whether the identifier has remained static in the second proximity zone and, if so, opens the opening element.

The present invention relates to a method of opening an opening element of a vehicle. It is applicable in particular, but not limited, to motor vehicles.

In the field of motor vehicles, a method of opening an opening element of a vehicle, known to the person skilled in the art, uses an identifier and comprises:
the authentication of said identifier by an electronic control unit of said vehicle,
the locating of said identifier by an electronic control unit, the locating comprising the determination of the distance of said identifier from said vehicle opening element,
the counting of the number of times the current distance is less than the previous distance,
if this number is greater than a determined maximum for a determined distance in proximity to the vehicle (often less than 2 meters), the opening of said opening element by said electronic control unit.

One drawback of this prior art is that it does not take into account the case where the user of the vehicle carrying the identifier approaches the opening element and stops in front of the opening element without wishing to open it. In the case of the cited prior art, the opening element still opens automatically.

In this context, the present invention aims to provide a method of opening an opening element of a vehicle which makes it possible to overcome the mentioned drawback.

To this end, the invention provides a method of opening an opening element of a vehicle, said opening method comprising:
the authentication of an identifier by an electronic control unit of said vehicle, wherein said opening method comprises:
the locating of said identifier by said electronic control unit in a first proximity zone around said vehicle,
if said identifier is located in said first proximity zone, the activation of a stop invitation signal intended for a user of said vehicle,
the detection by said electronic control unit of whether said identifier has remained static for a first determined period of time in said first proximity zone,
if yes, the detection by said electronic control unit of whether said identifier enters a second proximity zone around said opening element,
if yes, if said identifier enters said second proximity zone, the sending to said identifier by said electronic control unit of a confirmation signal of intention to open said opening element intended for said user,
the relay by said identifier of said opening intention confirmation signal via a man-machine interface,
the detection by said electronic control unit of whether said identifier has remained static for a second determined period of time in said second proximity zone,
if yes, the opening by said electronic control unit of said opening element.

Thus, as will be seen in detail below, by virtue of two spatio-temporal verifications of the identifier, the opening method makes it possible to take into account the intention of the user to open an opening element of the vehicle and avoids automatically opening said opening element when the user does not wish to do so.

According to non-limiting embodiments, said method of opening an opening element of a vehicle may further comprise, alone or in any technically possible combination, one or more additional features selected from the following.

According to one non-limiting embodiment, the activation of said stop invitation signal is performed by said vehicle.

According to one non-limiting embodiment, said stop invitation signal is a welcome scenario.

According to one non-limiting embodiment, the activation of said stop invitation signal is performed by said identifier.

According to one non-limiting embodiment, said stop invitation signal is a sound signal, a voice signal, or a vibration.

According to one non-limiting embodiment, said authentication of said identifier is done via BLE communication between said identifier and said electronic control unit.

According to one non-limiting embodiment, said locating of said identifier is done via UWB communication between said identifier and said electronic control unit.

According to one non-limiting embodiment, said locating comprises trajectory tracking.

According to one non-limiting embodiment, a maximum time interval is defined between said first determined period of time and said second determined period of time.

According to one non-limiting embodiment, said first proximity zone corresponds to a welcome scenario zone.

According to one non-limiting embodiment, said second proximity zone corresponds to an unlocking zone of said opening element.

According to one non-limiting embodiment, said first proximity zone is larger than said second proximity zone and encompasses said second proximity zone.

According to one non-limiting embodiment, said identifier is a hands-free access identifier of said vehicle for accessing and/or starting said vehicle hands-free.

According to one non-limiting embodiment, said opening element is motorized.

Provision is furthermore made for a system for opening an opening element of a vehicle, said opening system comprising:
(a) an electronic control unit of said vehicle, configured to:
authenticate an identifier,
locate said identifier,
(b) said identifier configured to:
authenticate itself with said electronic control unit,
   wherein:
(a) said electronic control unit is further configured to:
locate said identifier in a first proximity zone around said vehicle,
if said identifier is located in said first proximity zone, activate a stop invitation signal intended for a user of said vehicle or transmit to said identifier activation information to activate a stop invitation signal intended for a user,
detect whether said identifier has remained static for a first determined period of time in said first proximity zone,
if yes, detect whether said identifier enters a second proximity zone around said opening element,
if yes, send to said identifier a confirmation signal of intention to open said opening element intended for said user,
detect whether said identifier has remained static for a second determined period of time in said second proximity zone,
if yes, open said opening element,
(b) said identifier is further configured to:
receive from said electronic control unit said opening intention confirmation signal intended for said user and relay it via a man-machine interface,
if said identifier is located in said first proximity zone, receive from said electronic control unit said activation information and activate a stop invitation signal intended for a user of said vehicle.

Provision is furthermore made for an electronic control unit configured to cooperate with an identifier, said electronic control unit being integrated in a vehicle and being configured to:
authenticate said identifier,
locate said identifier, wherein:
(a) said electronic control unit is further configured to:
locate said identifier in a first proximity zone around said vehicle,
if said identifier is located in said first proximity zone, activate a stop invitation signal intended for a user of said vehicle or transmit to said identifier activation information to activate a stop invitation signal intended for a user,
detect whether said identifier has remained static for a first determined period of time in said first proximity zone,
if yes, detect whether said identifier enters a second proximity zone around said opening element,
if yes, if said identifier enters said second proximity zone, send to said identifier a confirmation signal of intention to open said opening element intended for said user,
detect whether said identifier has remained static for a second determined period of time in said second proximity zone,
if yes, open said opening element.

The invention and the various applications thereof will be better understood on reading the following description and studying the accompanying figures:

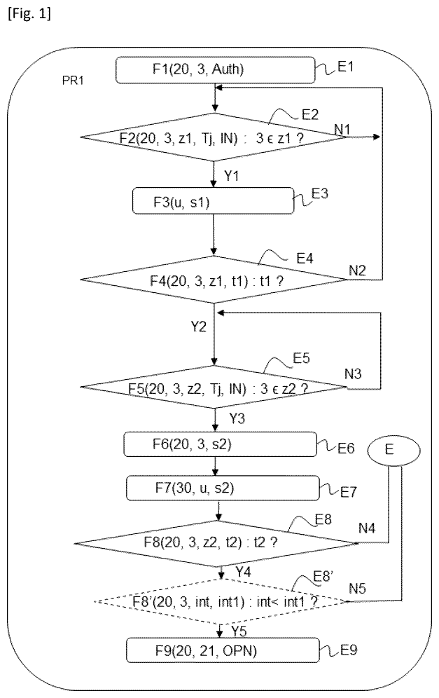

FIG. 1 is a flowchart of a method of opening an opening element of a vehicle, according to one non-limiting embodiment of the invention,

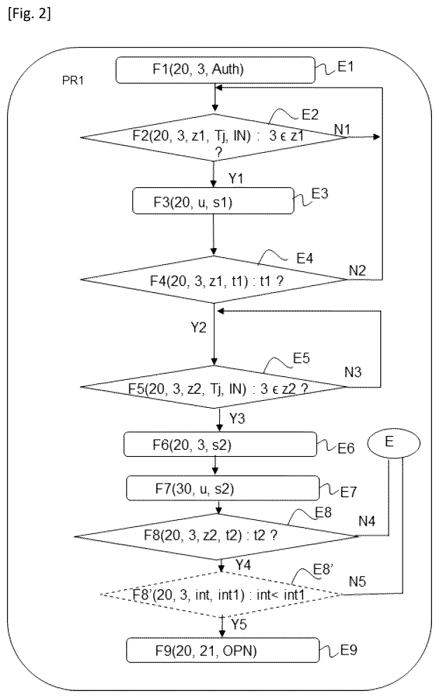

FIG. 2 illustrates the opening method of FIG. 1, according to a first non-limiting embodiment variant,

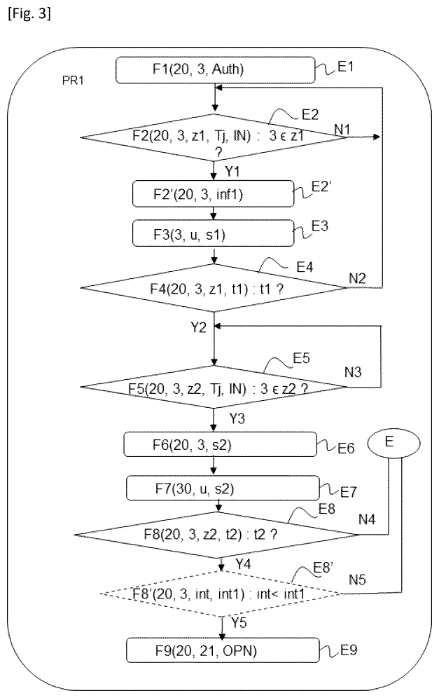

FIG. 3 illustrates the opening method of FIG. 1, according to a second non-limiting embodiment variant,

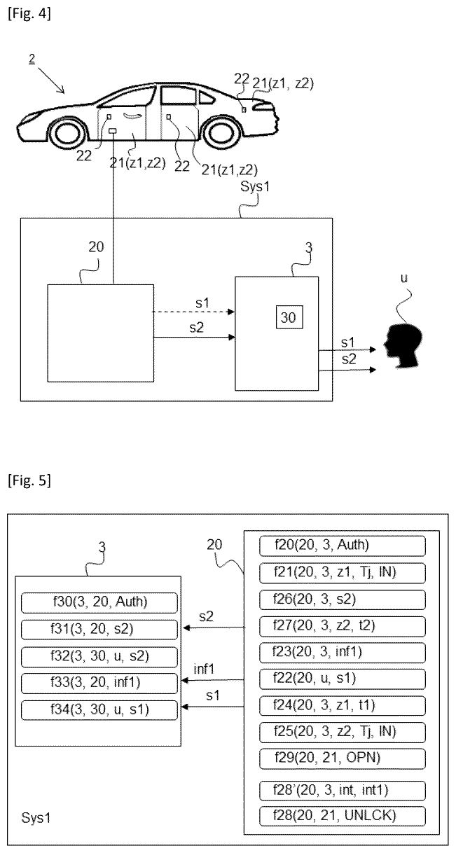

FIG. 4 is a schematic view of a system for opening an opening element of a vehicle configured to implement the opening method of FIGS. 1 to 3, said opening system comprising an identifier and an electronic control unit which is integrated in said vehicle, according to one non-limiting embodiment,

FIG. 5 illustrates said identifier and said electronic control unit of FIG. 4 and the functions thereof, according to one non-limiting embodiment,

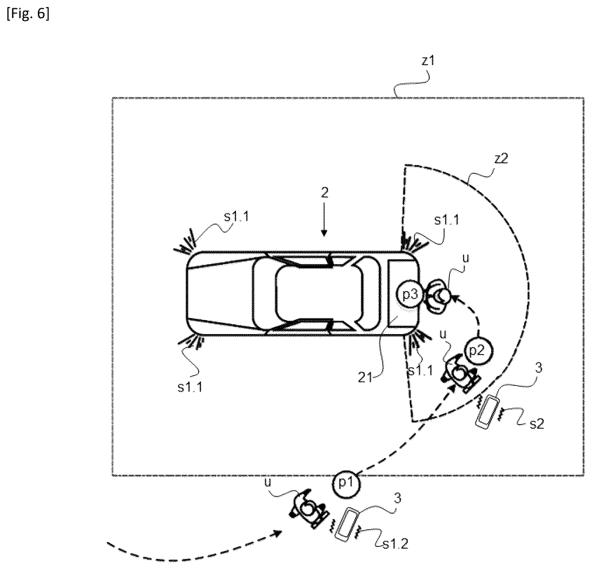

FIG. 6 illustrates a user carrying an identifier of FIG. 4 approaching a vehicle and entering a first proximity zone around said vehicle, then entering a second proximity zone around said opening element, according to one non-limiting embodiment.

Elements that are identical, in structure or in function, and that appear in several figures use the same reference signs, unless specified otherwise.

The method PR1 of opening an opening element 21 of a vehicle 2 according to the invention is described with reference to FIGS. 1 to 3.

In one non-limiting embodiment, the vehicle 2 is a motor vehicle. Motor vehicle is understood to mean any type of motorized vehicle. This embodiment is taken as a non-limiting example in the remainder of the description. In the remainder of the description, the vehicle 2 is thus also called a motor vehicle 2.

The motor vehicle 2 comprises a plurality of opening elements 21 (illustrated in FIG. 4). In some non-limiting embodiments, an opening element 21 is a trunk or a tailgate or a door of said motor vehicle 2. In the remainder of the description, the trunk or tailgate is referenced trunk/tailgate. A door may open laterally or be sliding or may be a side door which opens vertically. The opening element 21 which is opened by the opening method PR1 is motorized.

A first proximity zone z1 is defined around the motor vehicle 2. Furthermore, with each opening element 21 is associated a second proximity zone z2 around said opening element 21. In one non-limiting embodiment, the first proximity zone z1 corresponds to a welcome scenario zone. It will be noted that the advantage of using the welcome scenario as the first proximity zone z1 is using a zone which already exists in the motor vehicle 2. In one non-limiting embodiment, the first proximity zone z1 is situated approximately within 3.5 meters around said motor vehicle 2. In one non-limiting embodiment, the second proximity zone z2 corresponds to an unlocking zone of said opening element 21. It is an access zone to said opening element 21. In one non-limiting embodiment, the second proximity zone z2 is situated approximately within 2 meters around said corresponding opening element 21. It will be noted that the advantage of using the unlocking zone as the second proximity zone z2 is using a zone which already exists in the motor vehicle 2. Thus, said first proximity zone z1 is larger than said second proximity zone z2 and encompasses said second proximity zone z2. FIG. 6 illustrates the first proximity zone z1 and the second proximity zone z2 for the trunk/tailgate of the motor vehicle 2, according to one non-limiting embodiment.

The non-limiting embodiment of the trunk/tailgate is taken as a non-limiting example in the remainder of the description. Thus, for the sake of clarity, in FIG. 6 only the first proximity zone z1 and the second proximity zone z2 corresponding to the trunk/tailgate have been shown.

The opening method PR1 is implemented by an opening system Sys1 illustrated in FIGS. 4 and 5. As illustrated in FIG. 4, the detection system Sys1 comprises:
an identifier 3,
an electronic control unit 20 integrated in the motor vehicle 2.

In one non-limiting embodiment, the identifier 3 is a hands-free access identifier for accessing and/or starting said motor vehicle 2 hands-free. Thus, the identifier 3 may be used for a PEPS application (PEPS standing for Passive Entry Passive Start) allowing a user u of the motor vehicle 2 to unlock/lock and start the motor vehicle 2 by virtue of this identifier 3 without physically inserting said identifier 3 into a lock of said motor vehicle 2 to unlock/lock it or into an ignition switch of said motor vehicle 2 to start it. Thus, when it is located in proximity to the motor vehicle 2, the opening elements 21 may be unlocked, and when it is located inside the motor vehicle 2, the engine of the motor vehicle 2 may be started.

In some non-limiting embodiments, said identifier 3 is a smartphone or a key (with buttons) or a connected object such as wireless earphones or else a smartwatch. The smartphone or the connected object is thus used as a key to access and/or start the motor vehicle 2. The identifier 3 comprises one or more man-machine interfaces 30. In FIG. 4, only one man-machine interface 30 has been illustrated.

In one non-limiting embodiment, the electronic control unit 20, or ECU, is configured to communicate with the identifier 3 via the BLE communication protocol (BLE standing for Bluetooth Low Energy). To this end, it comprises a BLE communication module for communicating with a BLE communication module corresponding to the identifier 3 for the authentication (described below) of said identifier 3. Of course, other communication protocols may be used.

In one non-limiting embodiment, the electronic control unit 20 is further configured to cooperate with:
radio-frequency (RF) sensors referenced 22 in FIG. 4 which are installed all around said vehicle 2 to locate (described below) said identifier 3. In one non-limiting embodiment, these sensors are UWB or BLE sensors (UWB standing for Ultra-Wide Band).

According to one non-limiting embodiment, said locating of said identifier 3 is thus performed by means of:
UWB or BLE communication if said identifier 3 is a smartphone or a connected object or if the identifier 3 is a key, or
low-frequency (LF)-radio-frequency (RF) communication if said identifier 3 is a key, the key then comprising LF transmitters.

It will be noted that locating via BLE communication is done at around 50 meters or more (up to 400 meters in BLE 5.x). Locating via UWB communication is done at around 10 meters. Locating via LF-RF communication is done at around 3 meters. Of course, other communication protocols may be used.

It is recalled that radio-frequency (RF) operates in a frequency range of between 30 MHz and 300 GHz. In one non-limiting example, the RF frequency is at 433 MHz. It is recalled that UWB operates in a frequency range of between 3.2 GHZ and 8.3 GHz with a bandwidth of 500 MHz. It is recalled that BLE operates at 2.4 GHz. It is recalled that in one non-limiting example, the LF frequency is at 115 kHz.

In one non-limiting embodiment, the communication between the identifier 3 and the vehicle 2 is done in BLE. In this case, the identifier 3 and the vehicle 2 comprise BLE transceivers. In one non-limiting embodiment, the locating of the identifier 3 is done in UWB. In this case, the identifier 3 and the vehicle 2 comprise UWB sensors.

It will be noted that the UWB sensors comprise UWB communication modules and UWB antennas. The non-limiting example of UWB sensors is taken in the remainder of the description.

Since various communication techniques employing the various RF (for example BLE) protocols are known to the person skilled in the art, they are not described here. Since various locating techniques employing the various UWB and/or LF protocols are known to the person skilled in the art, they are not described here. In one non-limiting embodiment, the locating is performed periodically. In one non-limiting embodiment, it is done several times per second. Thus, this makes it possible to detect whether the identifier 3 (and therefore its user u) has returned to a proximity zone z1 or z2 (described below) after having left it for example.

As illustrated in FIG. 1, the opening method PR1 comprises the steps described below. As will be seen below, the identifier 3 will serve as a communication relay between the motor vehicle 2 and the user u. Specifically, at the instigation of the motor vehicle 2, the identifier 3 will transmit certain information to the user u to allow the automatic opening of an opening element 21. In the non-limiting example taken, the opening element 21 is the trunk or tailgate of the motor vehicle 2.

In a step E1 illustrated F1(20, 3, Auth) in FIG. 1, the electronic control unit 20 authenticates the identifier 3. This makes it possible to authorize a connection between the identifier 3 and the motor vehicle 2. In one non-limiting embodiment, the authentication is done via BLE communication between said identifier 3 and said electronic control unit 20. In the case of BLE, the connection is done when the identifier 3 is situated around 50 meters around the motor vehicle 2. Thus, when the identifier 3 is authenticated, a connection is established between it and the electronic control unit 20 and it may thus communicate with the motor vehicle 2, in particular with the electronic control unit 20.

In a step E2 illustrated F2(20, 3, z1, Tj, IN) in FIG. 1, the electronic control unit 20 locates the identifier 3 in the first proximity zone z1. In one non-limiting embodiment, said locating of said identifier 3 is done via UWB communication between said identifier 3 and said electronic control unit 20. This UWB communication makes it possible to have locating which comprises trajectory tracking Tj, namely the electronic control unit 20 knows the coordinates x, y, z of the identifier 3 at any instant when the identifier 3 approaches the motor vehicle 2. Thus, the locating is very accurate. This makes it possible, on the one hand, to see the user u arrive from greater distances and thus prepare the stop invitation notification described below, and, on the other hand, to check (using the trajectory tracking (x, y)) that the stop of the user u which is done subsequently is done within a limited given time after said notification.

Thus, if the identifier 3 is located by the electronic control unit 20 in the first proximity zone z1 (branch Y1), in a step E3 illustrated F3(u, s1) in FIG. 1, a stop invitation signal s1 intended for the user u of said motor vehicle 2 is activated.

It will be noted that as long as the identifier 3 has not entered the first proximity zone z1, the locating is reiterated (branch N1 illustrated). It will be noted that while the identifier 3 is in the first proximity zone z1, the locating is also still reiterated. This makes it possible to check that it is still in said first proximity zone z1. In one non-limiting example, the locating is performed every 96 ms (milliseconds).

In a first non-limiting embodiment variant illustrated in FIG. 2, the activation of the stop invitation signal s1 is performed by the motor vehicle 2 itself (step illustrated F3(20, u, s1)). In particular, it is the electronic control unit 20 which activates the stop invitation signal s1. In this case, in one non-limiting embodiment, said stop invitation signal s1 is a welcome scenario. Thus, when the user u with their identifier 3 enters the first proximity zone z1, light sources (not illustrated) of the motor vehicle 2 light up to perform the welcome scenario.

In a second non-limiting embodiment variant illustrated in FIG. 3, the activation of the stop invitation signal s1 is performed by the identifier 3 itself. In this case, the electronic control unit 20 transmits activation information inf1 to the identifier 3 to indicate to it that it must activate the stop invitation signal s1 (step F2′(20, 3, inf1) illustrated). The latter receives it and activates the stop activation signal s1 (step F3(3, u, s1) illustrated). In this case, in some non-limiting embodiments, said stop invitation signal s1 is a sound signal, a voice signal, or a vibration. Thus, the identifier 3 uses its man-machine interface 30 to transmit the sound signal, the voice signal or the vibration to the user u.

Thus, as illustrated in FIG. 6, if the user u enters the first proximity zone z1 (position p1 illustrated), and upon reception of this stop invitation signal s1, the user u knows that they must stop for a few moments. They therefore stop. Then, they may move toward the trunk/tailgate again. In FIG. 6, the stop invitation signal s1 is either a welcome scenario (signal referenced s1.1 in the figure) where the two front headlights and the two rear lights light up in the non-limiting example illustrated, or a vibration (signal referenced s1.2 in the figure) of said identifier 3.

It will be noted that the two non-limiting embodiment variants may be combined. Thus, if the identifier 3 is located in the first proximity zone z1, the welcome scenario is activated and at the same time, the user u perceives a sound signal, a voice signal or a vibration on the identifier 3.

In a step E4 illustrated F4(20, 3, z1, t1) in FIG. 1, the electronic control unit 20 detects whether the identifier 3 has remained static for a first determined period of time t1 in the first proximity zone z1. In one non-limiting example, t1 is between 500 milliseconds and 2 seconds. The motor vehicle 2 thus detects that the user u has stopped in the present case. After stopping, the user u may continue to move toward the trunk/tailgate.

In a step E5 illustrated F5(20, 3, z2, Tj, IN) in FIG. 1, if yes (branch Y2), the electronic control unit 20 detects whether said identifier 3 then enters the second proximity zone z2 around said opening element 21. Thus, the motor vehicle 2 detects whether the user u with their identifier 3 continues to move toward the trunk/tailgate. In the non-limiting embodiment, this detection, which is a locating operation, is done via UWB communication which makes it possible to have locating which comprises trajectory tracking Tj.

It will be noted that so long as the identifier 3 has not entered the second proximity zone z2, the locating is reiterated (branch N3 illustrated). In one non-limiting example, the locating is performed every 96 ms (milliseconds). It will be noted that while the identifier 3 is in the second proximity zone z2, the locating is still reiterated. This makes it possible to check that it is still in said second proximity zone z2. In general, by virtue of the locating, the electronic control unit 20 knows where the identifier 3 is located with respect to the motor vehicle 2 at any time.

In a step E6 illustrated F6(20, 3, s2) in FIG. 1, if yes (branch Y3), if said identifier 3 has entered the second proximity zone z2 around said opening element 21, the electronic control unit 20 sends to the identifier 3 a confirmation signal of intention to open s2 said opening element 21 intended for said user u and the identifier 3 relays this opening intention confirmation signal s2 via its man-machine interface 30 (step E7 illustrated F7(30, u, s2)). It will be noted that the man-machine interface 30 may be the same as that which transmits the stop invitation signal s1 or a different man-machine interface 30. In the non-limiting example of the figure, it is the same. In one non-limiting embodiment, said opening intention confirmation signal s2 is a sound signal, a voice signal, or a vibration or a combination of the signals, vibration.

Thus, after having marked a first stop time, if the user u enters the second activity zone z2 as illustrated in FIG. 6 (position p2), the motor vehicle 2 transmits to them, via the identifier 3, a second signal, here the opening intention confirmation signal s2 which asks them if they confirm their intention to open the opening element 21, here the trunk/tailgate of the motor vehicle 2. In the non-limiting example illustrated in FIG. 6, the opening intention confirmation signal s2 is a vibration of said identifier 3.

If no, if the identifier 3 has not entered the second proximity zone z2, the electronic control unit 20 acts as in the conventional locating cases parametrized by the manufacturers for the PEPS application. The no branch has not been illustrated in this case.

The confirmation of the intention of the user u to open the trunk/tailgate must be done by a second stop time. It will be noted that this second stop time (position p3 illustrated in FIG. 6) is done naturally when the user u wants the trunk/tailgate to open automatically, for example when they wish to put items therein and have their arms full.

Thus, in a step E8 illustrated F8(20, 3, z2, t2), the electronic control unit 20 detects whether the identifier 3 has remained static for a second determined period of time t2 in said second proximity zone z2. In one non-limiting example, t2 is between two seconds and ten seconds. The motor vehicle 2 thus detects that the user u has stopped a second time in the present case.

If yes (branch Y4), this means that the user u has stopped again to confirm their intention to open the trunk/tailgate. If no (branch N4), this means that the user has not stopped at all. Thus, they did not validate their intention to open the trunk/tailgate. For example, they went around the motor vehicle 2 without stopping a second time to mow the lawn. This ends the opportunity to automatically open the trunk/tailgate. The opening method PR1 stops (illustrated by step E).

Thus, in a step E9 illustrated F9(20, 21, OPN), the electronic control unit 20 opens the trunk/tailgate if the identifier 3 has remained static for the second determined period of time t2. Thus, the trunk/tailgate opens automatically, allowing the user u to open it without using their hands, in particular if their arms are full.

In one non-limiting embodiment, a maximum time interval int1 is defined between said first determined period of time t1 (in particular the end) and said second determined period of time t2 (in particular the start). In one non-limiting embodiment, the maximum time interval int1 is between 10 and 20 seconds. In one non-limiting embodiment variant, the maximum time interval int1 is between 16 and 20 seconds. This corresponds to a minimum travel speed (slow walk) to travel approximately 8 meters of distance to cross almost right through the first proximity zone z1 and reach the second proximity zone z2, for example when coming from the front of the vehicle 2 in the case of opening the tailgate/trunk.

Using the maximum time interval int1 makes it possible:
to have a fluid and robust user experience. For example, waiting 10 seconds at 3.5 meters from the user's vehicle when they are in a hurry is not considered to be very fluid,
to have robust validation after the indication of the intention to open an opening element 21.

The maximum time interval int1 makes it possible to eliminate interference cases where the first intention stop was not desired (for example if the user mows the lawn or stops on the way to talk, type an SMS, etc.).

The maximum time interval int1 is thus calibrated to:
distinguish as quickly as possible the temporary stop related to the automatic opening service of an opening element 21 from a prolonged stop not related to the automatic opening service of an opening element 21,
allow the average user to be able to perform the second stop at their own pace.

Thus, if the user u stops the second time but after this time interval int1 has exceeded, step E9 is not performed. The trunk/tailgate does not open.

Thus, in a step F8′ illustrated E8′(20, 3, int, int1), the electronic control unit 20 determines whether the time interval int, between the first time when the identifier 3 has remained static and the second time when it has remained static, is less than the maximum time interval int1. Since this step is optional, it is illustrated in dashed lines. If yes (branch Y5), the method moves on to step E9. If no (N5), this means, for example, that the user u took too long to stop the second time. Thus, they did not validate their intention to open the trunk/tailgate. This ends the opportunity to automatically open the trunk/tailgate. The opening method PR1 stops (illustrated by step E). This means that the first stop is only a coincidence. By virtue of the test with the time interval int, undesired interference cases are thus reduced. If the user takes too long to stop the second time, it means they do not voluntarily wish to invoke the automatic opening service of the opening element 21. It may be the case where the user u mows the lawn in the vicinity of the motor vehicle 2 and stops from time to time around it in a non-limiting example.

Thus, by virtue of the two stop times marked by the user in two different proximity zones z1 and z2 over a respective given time window t1, t2, the opening method PR1 makes it possible to be certain of the intention of the user to open an opening element 21. The first spatio-temporal stop defined by the first proximity zone z1 and the first period of time t1 makes it possible to check the intention of the user u a first time, and the second spatio-temporal stop defined by the second proximity zone z2 and the second period of time t2 makes it possible to confirm the intention of the user u a second time.

Thus, the opening method PR1 described is implemented by the system Sys1 for opening an opening element 21 of a vehicle 2 illustrated in FIGS. 4 and 5, according to a non-limiting embodiment.

The identifier 3 of the opening system Sys1 is configured to authenticate itself with the electronic control unit 20 (function f30(3, 20, Auth) illustrated in FIG. 5). Since various methods for authenticating an identifier 3 are known to the person skilled in the art, they are not described here.

The identifier 3 is further configured to:
receive from said electronic control unit 20 said opening intention confirmation signal s2 intended for said user u (function f31(3, 20, s2) illustrated in FIG. 5), and
relay it via a man-machine interface 30 (function f32(3, 30, u, s2) illustrated in FIG. 5). The identifier 3 thus serves as a relay for relaying instructions from the motor vehicle 2 to the user u.

According to one non-limiting embodiment, the identifier 3 is further configured to:
if said identifier 3 is located in said first proximity zone z1, receive from said electronic control unit 20 said activation information inf1 (function f33(3, 20, inf1) illustrated in FIG. 5), and
activate said stop invitation signal s1 intended for a user u of said vehicle 2 (function f34(3, 30, u, s1) illustrated in FIG. 5). It does so via a man-machine interface 30. The identifier 3 thus serves as a relay for relaying instructions from the motor vehicle 2 to the user u.

In one non-limiting embodiment, the stop invitation signal s1 is configurable by the user u. Thus, said signal may indicate whether the user wishes to receive a sound signal, a voice signal, a vibration or see a welcome scenario to stop the first time or a combination of these signals, vibration, scenario. In one non-limiting embodiment, the opening intention confirmation signal s2 is configurable by the user u. Thus, said signal may indicate whether the user wishes to receive a sound signal, a voice signal, or a vibration or a combination of these signals, vibration, to stop the second time.

It will be noted that the identifier 3 comprises an electronic control unit (not illustrated) for performing the functions described above.

The electronic control unit 20 is configured to authenticate said identifier 3 (function f20(20, 3, Auth) illustrated in FIG. 5).

The electronic control unit 20 is further configured to locate said identifier 3 in a first proximity zone z1 around said motor vehicle 2 (function f21(20, 3, z1, Tj, IN) illustrated in FIG. 5).

FIG. 6 illustrates the various positions p of a user u carrying said identifier 3 approaching the motor vehicle 2. When the user u approaches the motor vehicle 2 and enters the first proximity zone z1 associated with the trunk/tailgate, they are in position p1. The electronic control unit 20 locates it in this first proximity zone z1 by means of the UWB sensors in the non-limiting example taken.

When said identifier 3 is located in the first proximity zone z1, the electronic control unit 20 is further configured to:
activate said stop invitation signal s1 intended for the user u (function illustrated f22(20, u, s1) in FIG. 5). Thus, the welcome scenario is triggered in the non-limiting example, or
transmit to said identifier 3 activation information inf1 to activate said stop invitation signal s1 intended for a user u (function illustrated f23(20, 3, inf1) in FIG. 5).

The electronic control unit 20 is further configured to detect whether said identifier 3 remained static for a first determined period of time t1 in said first proximity zone z1 (function f24(20, 3, z1, t1) illustrated in FIG. 5). Thus, it looks at whether the identifier 3 has remained static in its position, here p1.

If yes, the electronic control unit 20 is further configured to detect whether said identifier 3 enters the second proximity zone z2 around an opening element 21 of said motor vehicle 2 (function f25(20, 3, z2, Tj, IN) illustrated in FIG. 5), therefore after it has remained static in the first proximity zone z1 for the first determined period of time t1. In FIG. 6, when the identifier 3 enters the second proximity zone z2, it is in position p2.

If yes, if the identifier 3 enters the second proximity zone z2, the electronic control unit 20 is further configured to send to said identifier 3 a confirmation signal of intention to open s2 said opening element 21 intended for said user u (function f26(20, 3, s2) illustrated in FIG. 5).

After having entered the second proximity zone z2, the user may move forward to the trunk/tailgate and stop in front of it. They are in position p3 in FIG. 6.

Moreover, the electronic control unit 20 is further configured to detect whether said identifier 3 remains static for a second determined period of time t2 in said second proximity zone z2 (function f27(20, 3, z2, t2) illustrated in FIG. 5) when it is in said second proximity zone z2. Thus, it looks at whether the identifier 3 has remained static in its position, here p3.

In addition, in one non-limiting embodiment, the electronic control unit 20 is further configured to determine whether the time interval int, between the first time the identifier 3 remained static and the second time it remained static, is less than the maximum time interval int1 (function f28′(20, 3, int, int1) illustrated in FIG. 5).

Finally, if this is the case, the electronic control unit 20 is further configured to open said opening element 21 (function f29(20, 21, OPN) illustrated in FIG. 5).

In one non-limiting embodiment, if the opening element 21 was not previously unlocked, the electronic control unit 20 is further configured to unlock said opening element 21 before opening it (function f28(20, 21, UNLCK) illustrated in FIG. 5).

Of course, the description of the invention is not limited to the embodiments described above and to the field described above. Thus, the trunk/tailgate has been taken as a non-limiting example of an opening element 21. However, in another non-limiting embodiment, the opening element 21 may also be a motorized side door which opens automatically to allow side access to the motor vehicle 2. In another non-limiting embodiment, when the user u has stopped for the first time, the identifier 3 having remained static for the first determined period of time t1, the electronic control unit 20 may be further configured to transmit an information signal intended for the user u (directly or via the identifier 3) to indicate to them that the motor vehicle 2 has understood that they had stopped in order to open the opening element 21.

Thus, the described invention in particular has the following advantages:
it allows an opening element 21 to open automatically without the manual intervention of the user u to open the opening element 21, and this in a reliable manner; the user only has to mark a first stop time, then naturally continue to walk up to the opening element 21 in question, and naturally stop in front of it and wait for it to open automatically,
it makes it possible to avoid the case in which an opening element 21 opens automatically when the user u approaches the opening element 21 with their identifier 3 and stops in front of it while the user u does not intend for the opening element 21 to open,
it makes it possible to detect the intention of the user u to open an opening element 21 of the vehicle 2 and to confirm it,
it makes it possible to avoid equipping the vehicle 2 with a foot movement sensor, also called a “kick sensor”, the latter being very sensitive to the slightest movement and being able to detect interference movements such as a cat passing by, which cause an opening element 21 such as the trunk or tailgate to open undesirably; thus, by virtue of the solution of the invention, the cost of the vehicle 2 is reduced because it does not have such a movement sensor,
it is simple to implement.

1. A method of opening an opening element of a vehicle, the opening method (PR1) comprising:
an authentication of an identifier by an electronic control unit of the vehicle,
locating of the identifier by the electronic control unit in a first proximity zone around the vehicle,
when the identifier is located in the first proximity zone, performing an activation of a stop invitation signal intended for a user (u) of the vehicle,
detecting by the electronic control unit of whether the identifier has remained static for a first determined period of time in the first proximity zone,
when the identifier has remained static for the first determined period of time, detecting by the electronic control unit of whether the identifier enters a second proximity zone around the opening element,
when the identifier enters the second proximity zone, sending to the identifier by the electronic control unit a confirmation signal of intention to open the opening element intended for the user,
relaying by the identifier the confirmation signal via a man-machine interface,
detecting by the electronic control unit whether the identifier has remained static for a second determined period of time in the second proximity zone,
when the identifier has remained static for the second determined period of time, opening by the electronic control unit the opening element.

2. The opening method as claimed in claim 1, wherein the activation of the stop invitation signal is performed by the vehicle.

3. The opening method as claimed in claim 1, wherein the stop invitation signal is a welcome scenario.

4. The opening method as claimed in claim 1, wherein the activation of the stop invitation signal is performed by the identifier.

5. The opening method as claimed in claim 1, wherein the stop invitation signal is a sound signal, a voice signal, or a vibration.

6. The opening method as claimed in claim 1, wherein the authentication of the identifier is done via Bluetooth Low Energy (BLE) communication between the identifier and the electronic control unit.

7. The opening method as claimed in claim 1, in which the locating of the identifier is done via Ultra-Wide Band (UWB) communication between the identifier and the electronic control unit.

8. The opening method as claimed in claim 7, wherein the locating comprises trajectory tracking.

9. The opening method as claimed in claim 1, wherein a maximum time interval is defined between the first determined period of time and the second determined period of time.

10. The opening method as claimed in claim 1, wherein the first proximity zone corresponds to a welcome scenario zone.

11. The opening method as claimed in claim 1, wherein the second proximity zone corresponds to an unlocking zone of the opening element.

12. The opening method as claimed in claim 1, wherein the first proximity zone is larger than the second proximity zone and encompasses the second proximity zone.

13. The opening method as claimed in claim 1, wherein the identifier is a hands-free access identifier of the vehicle for accessing and/or starting the vehicle hands-free.

14. A system for opening an opening element of a vehicle, the opening system comprising:
an electronic control unit of the vehicle, configured to:
authenticate an identifier,
locate the identifier,
the identifier configured to:
authenticate itself with the electronic control unit,
wherein:
the electronic control unit is further configured to:
locate the identifier in a first proximity zone around the vehicle,
when the identifier is located in the first proximity zone, activate a stop invitation signal intended for a user of the vehicle or transmit to the identifier activation information to activate a stop invitation signal intended for a user,
detect whether the identifier has remained static for a first determined period of time in the first proximity zone,
when the identifier has remained static for the first determined period of time, detect whether the identifier enters a second proximity zone around the opening element,
when the identifier enters the second proximity zone, send to the identifier a confirmation signal of intention to open the opening element intended for the user,
detect whether the identifier has remained static for a second determined period of time in the second proximity zone,
when the identifier has remained static for a second determined period of time, open the opening element,
the identifier is further configured to:
receive from the electronic control unit the confirmation signal intended for the user and relay it via a man-machine interface,
when the identifier is located in the first proximity zone, receive from the electronic control unit activation information (inf1) and activate a stop invitation signal intended for a user of the vehicle.

15. An electronic control unit configured to cooperate with an identifier, the electronic control unit being integrated in a vehicle and being configured to:
authenticate the identifier,
locate the identifier,
wherein:
the electronic control unit is further configured to:
locate the identifier in a first proximity zone around the vehicle,
when the identifier is located in the first proximity zone, activate a stop invitation signal intended for a user of the vehicle or transmit to the identifier activation information to activate a stop invitation signal intended for a user,
detect whether the identifier has remained static for a first determined period of time in the first proximity zone,
when the identifier has remained static for the first determined period of time, detect whether the identifier enters a second proximity zone around the opening element,
when the identifier enters the second proximity zone, send to the identifier a confirmation signal of intention to open the opening element intended for the user,
detect whether the identifier has remained static for a second determined period of time in the second proximity zone,
when the identifier has remained static for the second determined period of time, open the opening element.
